(19) United States
(12) Patent Application Publication
(10) Pub. No.: US 2008/0005249 A1
(43) Pub. Date: Jan. 3, 2008

(54) Method and apparatus for determining the importance of email messages

(76) Inventor: Matt E. Hart, Lunenberg, MA (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/480,719

(22) Filed: Jul. 3, 2006

(51) Int. Cl. G06F 15/16

(52) U.S. Cl. 709/206

(57) ABSTRACT

A system that determines the importance of an email message. During operation, the system receives the email message destined to a user within a social network. Next, the system determines a frequency of interaction with a sender of the email message by members of the social network and assigns an importance score to the email message based on the determined frequency of interaction with the sender. The system then uses the importance score for the email message to perform an action involving the email message.

### BACKGROUND

Related Art

Email has become an indispensable part of today's information economy. Employees are constantly bombarded with tens, if not hundreds, of emails every day. As a result, they often spend a substantial part of their workday plodding through mountains of email messages whose subject matter can range from the utterly trivial to the extremely important. Moreover, this problem has been exacerbated by the exponential increase in spam over the recent years.

One prior art technique to mitigate this problem involves classifying incoming email messages using rules. For example, email addresses of friends and business associates can be placed on a “whitelist,” which can then be used to identify valid email messages. Similarly, email addresses from known spammers can be placed on a “blacklist,” which can be used to identify junk email messages. Although such rule-based techniques can be used to separate valid emails from junk emails, they are not useful for separating the important email message from the unimportant ones. Hence, users may still have to spend a substantial amount of time reading emails to determine their importance.

Another technique to solve this problem uses the communication history between an email message's recipient and its sender to determine the importance of the email message. For example, an email message from a sender may be assigned a high importance if the recipient frequently receives emails from the sender.

Unfortunately, this technique can make mistakes while determining the importance of an email message. Specifically, if an email message arrives from a sender with whom the user has never communicated, the email message may be assigned a low importance, even though the email message may be very important. For example, if an employee's boss directs a new vendor to discuss a project with the employee, the ensuing email message from the vendor may be ignored by the employee because it was not assigned a high importance.

### SUMMARY

One embodiment of the present invention provides a system that determines the importance of an email message. During operation, the system receives an email message from a sender which is destined to a user who belongs a social network. Next, the system determines a frequency of interaction between the sender and the members of the social network. The system then assigns an importance score to the email message using the frequency of interaction. Next, the system uses the importance score to perform an action involving the email message.

In a variation on this embodiment, the system determines the frequency of interaction with the sender by analyzing a frequency with which members of the social network have responded to the sender.

In a variation on this embodiment, the system determines the frequency of interaction with the sender by analyzing a frequency with which members of the social network have clicked on links contained in messages sent by the sender.

In a variation on this embodiment, the system determines whether members of the social network apply a rule when they receive email messages from the sender. If so, the system applies the rule to the email message.

In a further variation, if members of the social network have determined that the sender sends junk emails, the system moves the email message to a junk email folder.

In a further variation, if members of the social network have determined that the sender sends automated-order responses, the system moves the email message to an orders folder.

In a further variation, if members of the social network have placed the sender on a blacklist, the system moves the email message to a junk email folder.

In a further variation, if members of the social network have placed the sender on a whitelist, the system marks the email message as a valid email message.

In a variation on this embodiment, information about the frequency of interaction with senders of email messages is stored on a shared gateway.

In a variation on this embodiment, information about the frequency of interaction with senders of email messages is stored on a client system operated by the user.

In a variation on this embodiment, the importance of the email message is determined by an email server application at a shared gateway.

In a variation on this embodiment, the importance of the email message is determined by an email client application executing on a client system operated by the user.

In a variation on this embodiment, the importance of an email message is determined by an organizational hierarchy of the social network.

### BRIEF DESCRIPTION OF THE FIGURES

FIG. 1A presents a block diagram illustrating an email server that determines the importance of an email message using rules stored on the email server in accordance with an embodiment of the present invention.

FIG. 1B presents a block diagram illustrating a client that determines the importance of an email message using rules stored on an email server in accordance with an embodiment of the present invention.

FIG. 1C presents a block diagram illustrating an email server that determines the importance of an email message using rules stored on a client in accordance with an embodiment of the present invention.

FIG. 1D presents a block diagram illustrating a client that determines the importance of an email message using rules stored on the client in accordance with an embodiment of the present invention.

FIG. 2 presents a flow chart illustrating the process of determining the importance of an email message in accordance with an embodiment of the present invention.

FIG. 3 presents a flow chart illustrating the process of applying a specified rule to an email message in accordance with an embodiment of the present invention.

FIG. 4 presents a block diagram of a Microsoft® Exchange Server implementation of an email server that determines the importance of an email message in accordance with an embodiment of the present invention.

FIG. 5 presents a flow chart illustrating the process of applying a rule to an email message on a Microsoft® Exchange server in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), or any device capable of storing data usable by a computer system.

### Determining Importance of Email Messages

One embodiment of the present invention determines the importance of email messages by applying a set of rules that are shared within a social network. For example, a social network can include, but is not limited to, persons who belong to: a given company, a given family, a given group of friends, or a given group of people with similar interests.

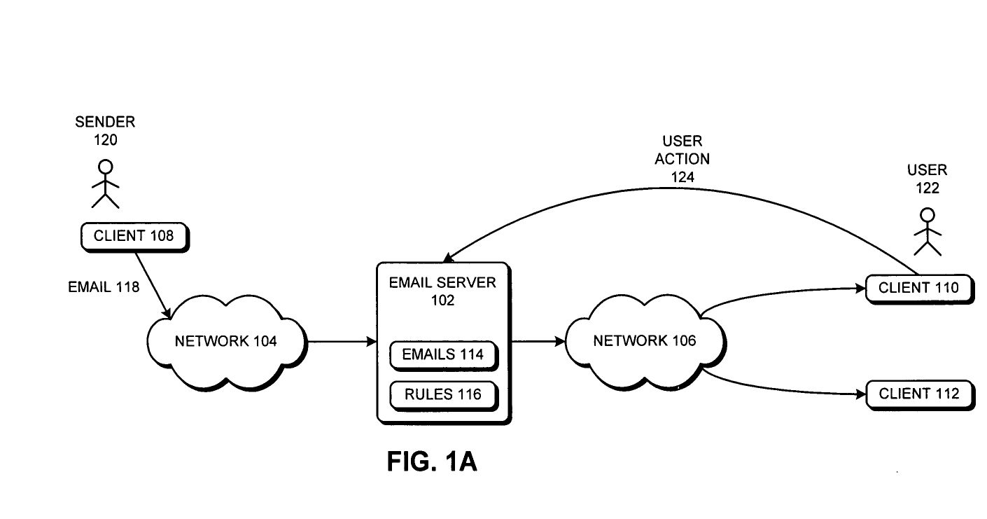

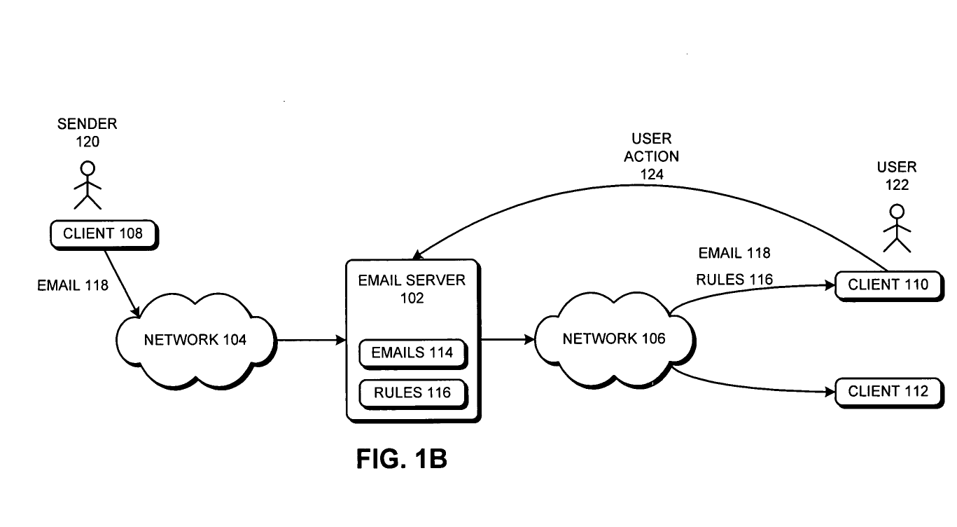

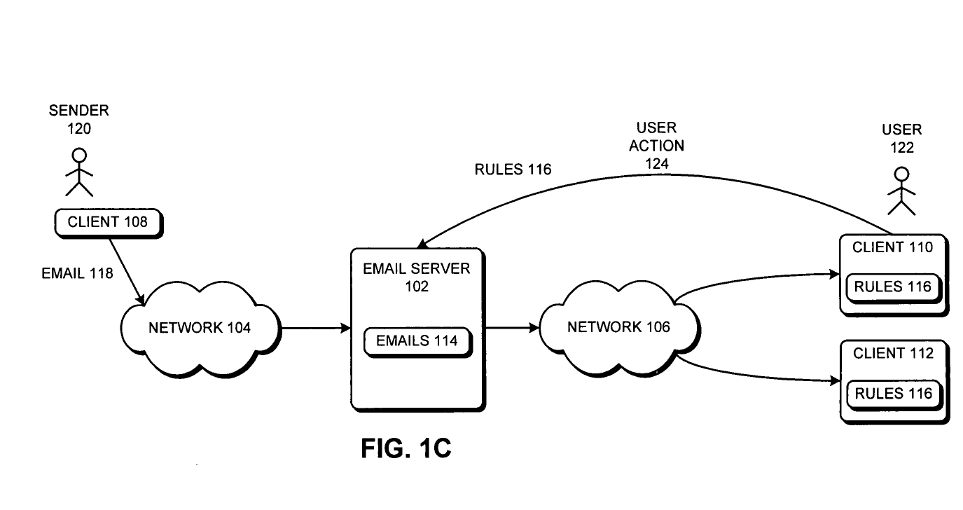

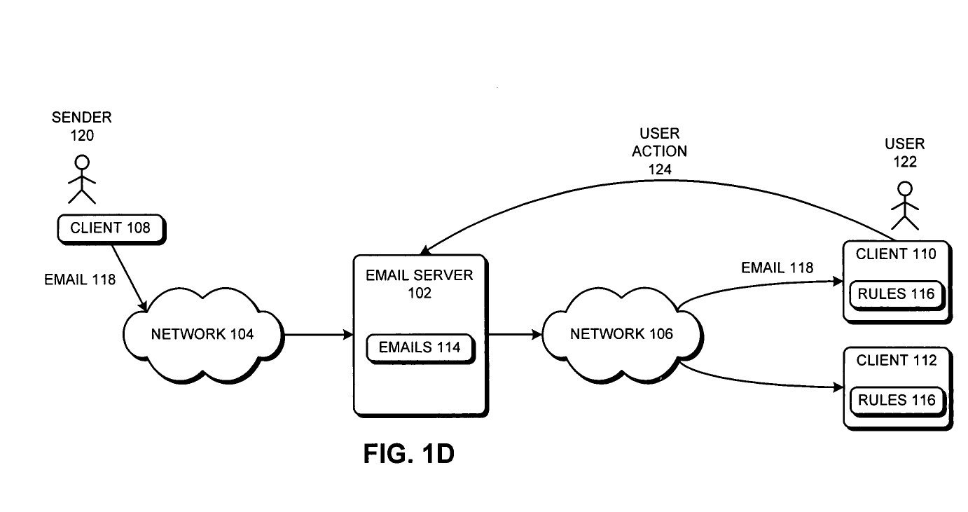

FIG. 1A presents a block diagram illustrating email server 102 that determines the importance of an email message using rules 116 stored on email server 102 in accordance with an embodiment of the present invention.

Sender 120 on client 108 sends email 118 destined for user 122 through network 104. Email server 102 receives email 118 for user 122. Email server 102 then uses rules 116 to determine the importance of email 118, and assigns an importance score to email message 118. At a later time, user 122 on client 10 retrieves email 118 along with the associated importance score from email server 102 through network 106. Note that although the present disclosure discusses one user (or sender) per client, multiple users (or senders) can use a given client to retrieve email messages.

Email server 102 can generally include any computational node including a mechanism for servicing requests from a client for computational and/or data storage resources.

Networks 104 and 106 can generally include any type of wired or wireless communication channel capable of coupling together computing nodes. This includes, but is not limited to, a local area network, a wide area network, or a combination of networks. In one embodiment of the present invention, networks 104 and 106 include the Internet. Note that networks 104 and 106 can be the same network or they can be different networks. Additionally, networks 104 and 106 can be different sub-networks within a larger network.

Clients 108-112 can generally include any node on a network that comprises a mechanism for communicating across the network. Email server 102 can be located at a shared gateway for the social network.

The importance of the email message can be determined by an email server application at a shared gateway. Further, the importance of the email message can be determined by an email client application executing on a client system operated by the user.

In one embodiment of the present invention, email server 102 stores email 118 along with emails 114 until user 122 retrieves emails destined for user 122. Note that emails 114 can include email messages destined for other users.

Email server 102 can use an Internet Message Access Protocol (IMAP) to deliver emails destined for clients 110 and 112. Alternatively, email server 102 can use a Post Office Protocol (POP) to deliver emails destined for clients 110 and 112.

In one embodiment of the present invention, user 122 is part of a social network. In this embodiment, the rules used to determine the importance of an email message are specific to a given social network.

The rules used to determine the importance of an email message can include, but are not limited to: filters based on email addresses, filters based on Internet Protocol (IP) addresses, ranking techniques based on the frequency that members of the social network have replied to a sender, and ranking techniques based on the frequency that the members of the social network have clicked on links within email messages sent by the sender. The filters can be “blacklists,” which indicate unwanted email addresses or IP addresses, or they can be “whitelists,” which indicate valid email addresses or IP addresses.

In one embodiment of the present invention, the frequency of communication between members of a social network and sender 120 is used to determine the importance of email messages sent by sender 120 relative to email messages sent by other senders. Specifically, a higher frequency of communication between members of the social network and a sender can be associated with a higher importance score.

Note that by looking at the frequency of communication between members of a social network and senders, emails sent by senders who have previously never communicated with a given user can be classified according to the rules set by members of the social network. This is in contrast to prior art techniques which determine the importance of an email message based on only the communication frequency between the sender and the recipient. However, as explained before, this can cause prior art approaches to make serious mistakes in determining the importance of an email message.

Embodiments of the present invention do not suffer from these drawbacks because they determine the importance of an email message using the communication history between the sender and the members of the social network. Hence, even if a recipient has never received an email from a sender, if the sender is well known and highly regarded by other members of the social group, the recipient will correctly assign a high importance to an email from the sender. In addition to using the frequency of communication, embodiments can share rules and/or filters among the members of the social network.

In one embodiment of the present invention, the importance of an email message is determined by an organizational hierarchy of the social network. For example, if an employee's manager has been communicating with a vendor on a project, and at a later time directs the vendor to discuss the project with the employee, the system determines that an email message sent from the vendor to the employee is important based on the organizational hierarchy of the company.

In one embodiment of the present invention, the importance score of an email message determined by the organizational hierarchy of the social network is ranked relative to the organizational hierarchy. For example, if the president of a company directs a first vendor to discuss a project with an employee, the email message sent from the first vendor to the employee has a higher importance score than a second vendor who was directed to speak with the employee by the direct manager of the employee.

In one embodiment of the present invention, a social network determines the relative ranking of the importance score based on the organizational hierarchy. For example, a social network can decide that email messages from senders who have interacted with a direct manager of the employee are ranked higher than email messages from senders who have interacted with higher-level managers. Similarly, the social network can decide that email messages from senders who have interacted with higher-level managers are ranked higher than email messages from senders who have interacted with a direct manager of the employee.

In one embodiment of the present invention, the rules are shared within a social network. If user 122 performs user action 124 for email 1118, user action 124 is sent to email server 102 to be recorded in rules 116. For example, user action 124 is the action of replying to email 118. Hence, email server 102 notes that user 122 in the social network has replied to sender 120 and the frequency of interaction with sender 120 is incremented for the social network for which user 122 belongs.

One embodiment of the present invention moves email messages from specified senders to specified folders based on rules 116. For example, if members of a social network have determined that a sender is a sender of junk email, email messages from the sender are moved to a junk email folder. Similarly, if members of a social network have determined that a sender is a sender of automated order responses, email messages from the sender are moved to an orders folder. Likewise, if members of a social network have placed a sender of a blacklist, email messages from the sender are moved to a junk email folder. Alternatively, if members of a social network have placed a sender on a whitelist, email messages from the sender are marked as valid email messages.

In one embodiment of the present invention, email server 102 is at a shared gateway for clients 110-112. In another embodiment of the present invention, email server 102 is on a wide-area network (WAN) coupled to clients 110-112.

User 122 can have multiple email accounts and the importance of email messages for user 122 can be determined for all email accounts based on the rules established by each social network. In one embodiment, user 122 has multiple email accounts and the importance of email messages for user 122 is determined for each email account separately based on rules for each social network.

Emails destined for user 122 can be stored on different email servers until retrieved by user 122. For example, each unique email account for user 122 is stored on a different email server.

In one embodiment of the present invention, rules are gathered at clients 110-112 within the social network. In another embodiment of the present invention, rules are gathered at email server 102.

FIG. 1B presents a block diagram illustrating client 110 that determines the importance of an email message using rules 116 stored on email server 102 in accordance with an embodiment of the present invention.

Note that in FIG. 1A, email server 102 determines the importance of email messages, but in FIG. 1B, client 110 determines the importance of email messages. Hence, the discussion in FIG. 1A applies to FIG. 1B with the exception that when checking for new email messages, in addition to retrieving email 118 from email server 102, client 110 also retrieves rules 116 from email server 102. In one embodiment of the present invention, rules 116 are updated each time user 122 checks for new email messages. In another embodiment of the present invention, rules 116 are updated periodically on client 110, regardless of the frequency at which user 122 checks for emails.

FIG. 1C presents a block diagram illustrating email server 102 that determines the importance of an email message using rules stored on client 110 in accordance with an embodiment of the present invention.

Note that in FIG. 1A, email server 102 stores rules 116, but in FIG. 1C, client 110 stores rules 116. However, the discussion in FIG. 1A applies to FIG. 1C with the exception that in FIG. 1C, clients 110-112 store rules 116 locally. Hence, in one embodiment of the present invention, email server 102 first retrieves rules 116 from client 110 when user 122 checks for new email messages prior to determining the importance of email messages for user 122.

User 122 then retrieves emails directed to user 122 and performs actions on the emails. For example, user 122 performs user action 124. In one embodiment of the present invention, user action 124 marks email 118 as spam. As a result, sender 120 is placed on a blacklist. In one embodiment of the present invention, after user 122 performs user action 124, email server 102 receives notification of user action 124 from client 110. Email server 102 then sends an update of rules 116 to clients 110-112. In another embodiment of the present invention, client 110 broadcasts user action 124 to clients within the social network, including client 112, as well as broadcasting user action 124 to email server 102. Hence, clients that are not online at the time when client 110 broadcasts user action 124 can still receive updates from email server 102 when they come online.

FIG. 1D presents a block diagram illustrating client 110 that determines the importance of an email message using rules stored on client 110 in accordance with an embodiment of the present invention.

Note that in FIG. 1C, email server 102 determines the importance of email messages, but in FIG. 1D, client 110 determines the importance of email messages. Hence, the discussion in FIG. 1C applies to FIG. 1D with the exception that in FIG. 1D, client 110 uses rules 116, which are stored locally on client 110, to determine the importance of email messages.

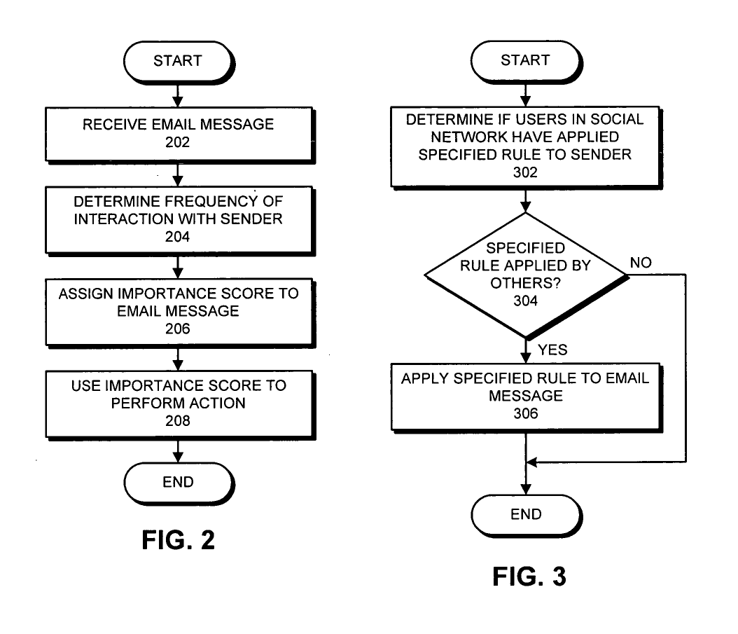

FIG. 2 presents a flow chart illustrating the process of determining the importance of an email message in accordance with an embodiment of the present invention.

The process begins when the system receives an email message destined for a user within a social network (step 202). Next, the system determines a frequency of interaction with a sender of the email message by members of the social network (step 204), and assigns an importance score to the email message based on the determined frequency of interaction with the sender (step 206). In one embodiment of the present invention, while determining the frequency of interaction with the sender, the system analyzes a frequency with which members of the social network have responded to the sender. In another embodiment of the present invention, while determining the frequency of interaction with the sender, the system analyzes a frequency with which members of the social network have clicked on links contained in messages sent by the sender.

The system then uses the importance score for the email message to perform an action involving the email message (step 208). In one embodiment of the present invention, the system uses the importance score for email messages to sort the email messages for the user relative to one another.

FIG. 3 presents a flow chart illustrating the process of applying a specified rule to an email message in accordance with an embodiment of the present invention.

The process begins when the system determines whether members of the social network have applied a specified rule to the sender of the email message (step 302 and 304). If so, the system applies the specified rule to the email message sent to the user from the sender (step 306).

### Microsoft® Exchange Server Implementation

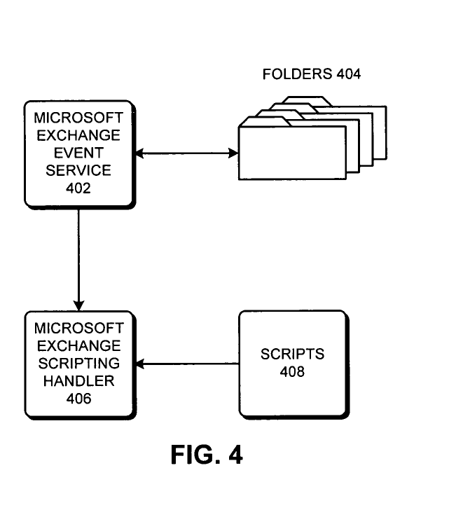

FIG. 4 presents a block diagram of a Microsoft® Exchange Server implementation of an email server that determines the importance of an email message in accordance with an embodiment of the present invention. (Note that “Microsoft” is either a registered trademark or a trademark of Microsoft Corporation in the United States and/or other countries.)

In FIG. 4, Microsoft Exchange Server Event Service 402 monitors folders 404. In one embodiment of the present invention, when an event is detected by Microsoft Exchange Server Event Service 402 (e.g., an email is received by Microsoft Exchange Server), Microsoft Exchange Server Event Service 402 calls IExchangeEventHandler::ExecuteEvent and passes information about the current session, information about folders 404, and information about the email message received to Microsoft Exchange Scripting Handler 406. Microsoft Exchange Scripting Handler 406 then processes scripts 408 that determine the importance of the email message.

In one embodiment of the present invention, a folder in folders 404 contains one or more scripts 408 which are applied to email messages in the folder.

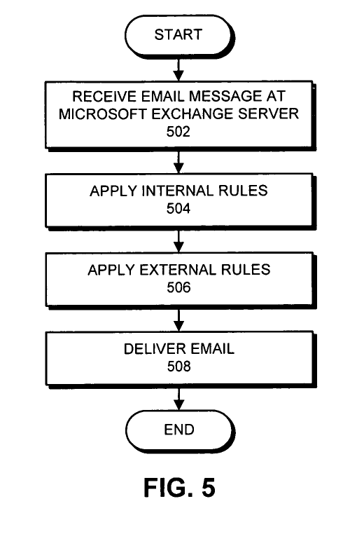

FIG. 5 presents a flow chart illustrating the process of applying a rule to an email message on a Microsoft® Exchange server in accordance with an embodiment of the present invention.

The process begins when Microsoft Exchange Server receives an email message (step 502). Next, Microsoft Exchange Server applies internal rules to the email message (step 504). In one embodiment of the present invention, the internal rules include, but are not limited to: Out-of-office Assistant, Distribution Lists, and Assistant routing.

Microsoft Exchange Server then applies external rules to the email message (step 506). In one embodiment of the present invention, the external rules include, but are not limited to: user-defined rules and rules determined by social networks as described above. Microsoft Exchange Server then delivers the email (step 508).

In one embodiment of the present invention, the process described in FIG. 5 is performed on a client.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for determining the importance of an email message, the method comprising:
receiving an email message from a sender which is destined to a user within a social network;
determining a first frequency of interaction between the sender and the members of the social network;
assigning an importance score to the email message using the first frequency; and
using the importance score to perform an action involving the email message.

2. The method of claim 1, wherein determining the first frequency of interaction with the sender involves:
analyzing a second frequency with which members of the social network have responded to the sender; or
analyzing a third frequency with which members of the social network have clicked on links contained in messages sent by the sender.

3. The method of claim 1, further comprising:
determining whether members of the social network apply a first rule to email messages that are received from the sender; and
if so, applying the first rule to the email message.

4. The method of claim 3, wherein determining whether members of the social network apply the first rule involves:
determining whether members of the social network have determined that the sender sends junk email;
determining whether members of the social network have determined that the sender sends automated-order responses;
determining whether members of the social network have placed the sender on a blacklist; or
determining whether members of the social network have placed the sender on a whitelist.

5. The method of claim 3, wherein applying the first rule to the email message involves:
moving the email message to a junk email folder;
moving the email message to an orders folder; or
marking the email message as a valid email message.

6. The method of claim 1, wherein information about the frequency of interaction with senders of email messages is stored on:
a shared gateway; or
a client system operated by the user.

7. The method of claim 1, wherein the method is performed by:
an email server application at a shared gateway; or
an email client application executing on a client system operated by the user.

8. The method of claim 1, wherein the importance of an email message is determined by an organizational hierarchy of the social network.

9. A computer-readable storage medium storing instructions that when executed by a computer cause the computer to perform a method for determining the importance of an email message, the method comprising:
receiving an email message from a sender which is destined to a user within a social network;
determining a first frequency of interaction between the sender and the members of the social network;
assigning an importance score to the email message using the first frequency; and
using the importance score to perform an action involving the email message.

10. The computer-readable storage medium of claim 9, wherein determining the first frequency of interaction with the sender involves:
analyzing a second frequency with which members of the social network have responded to the sender; or
analyzing a third frequency with which members of the social network have clicked on links contained in messages sent by the sender.

11. The computer-readable storage medium of claim 9, the method further comprising:
determining whether members of the social network apply a first rule to email message that are received from the sender; and
if so, applying the first rule to the email message.

12. The computer-readable storage medium of claim 11, wherein determining whether members of the social network apply the first rule involves:
determining whether members of the social network have determined that the sender sends junk email;
determining whether members of the social network have determined that the sender sends automated-order responses;
determining whether members of the social network have placed the sender on a blacklist; or
determining whether members of the social network have placed the sender on a whitelist.

13. The computer-readable storage medium of claim 11, wherein applying the first rule to the email message involves:
moving the email message to a junk email folder;
moving the email message to an orders folder; or
marking the email message as a valid email message.

14. The computer-readable storage medium of claim 9, wherein information about the frequency of interaction with senders of email messages is stored on:
a shared gateway; or
a client system operated by the user.

15. The computer-readable storage medium of claim 9, wherein the method is performed by:
an email server application at a shared gateway; or
an email client application executing on a client system operated by the user.

16. The computer-readable storage medium of claim 9, wherein the importance of an email message is determined by an organizational hierarchy of the social network.

17. An apparatus that determines the importance of an email message, comprising:
a receiving mechanism configured to receive an email message from a sender which is destined to a user within a social network;
a frequency-determining mechanism configured to determine a first frequency of interaction between the sender and the members of the social network;
a scoring mechanism configured to assign an importance score to the email message using the first frequency; and
an execution mechanism configured to use the importance score to perform an action involving the email message.

18. The apparatus of claim 17, wherein the frequency-determining mechanism is configured to:
analyze a second frequency with which members of the social network have responded to the sender; or to
analyze a third frequency with which members of the social network have clicked on links contained in messages sent by the sender.

19. The apparatus of claim 17, further comprising:
a determining mechanism configured to determine whether members of the social network apply a first rule to email messages that are received from the sender; and
an applying mechanism, wherein if the members of the social network apply the first rule to email messages that are received from the sender, the applying mechanism is configured to apply the first rule to the email message.

20. The apparatus of claim 19, wherein the determining mechanism is configured to:
determine whether members of the social network have determined that the sender sends junk email;
determine whether members of the social network have determined that the sender sends automated-order responses;
determine whether members of the social network have placed the sender on a blacklist; or to
determine whether members of the social network have placed the sender on a whitelist.

21. The apparatus of claim 19, wherein the applying mechanism is configured to:
move the email message to a junk email folder;
move the email message to an orders folder; or to
mark the email message as a valid email message.

22. The apparatus of claim 17, wherein information about the frequency of interaction with senders of email messages is stored on:
a shared gateway; or
a client system operated by the user.

23. The apparatus of claim 17, wherein the importance of an email message is determined by an organizational hierarchy of the social network.
